(19) United States
(12) Patent Application Publication
(10) Pub. No.: US 2021/0293683 A1
(43) Pub. Date: Sep. 23, 2021

(54) Device and Method for Measuring a Density of Provided Granular Matter

(71) Applicants: Research Center Pharmaceutical Engineering GmbH, Graz (AT); Technische Universität Graz, Graz (AT)

(72) Inventors: Johannes Khinast, Graz (AT); Thomas Klein, Kindberg (AT); Massimo Bresciani, Graz (AT); Eva Faulhammer, Graz (AT); Sandra Stranzinger, Graz (AT); Daniel Markl, Cambridge (GB); Jochen Axel Zeitler, Cambridge (GB)

(21) Appl. No.: 16/624,331

(22) PCT Filed: Jun. 26, 2018
(86) PCT No.: PCT/EP2018/067160

§ 371 Date: Dec. 19, 2019

(30) Foreign Application Priority Data
Jun. 27, 2017 (GB) 1710246.8

(51) Int. Cl. G01N 9/24; G01N 21/3563; G01N 21/3581; G01N 21/85

(52) U.S. Cl. CPC G01N 9/24; G01N 21/3563; G01N 2021/8592; G01N 21/85; G01N 21/3581

(57) ABSTRACT

A device and a method for providing granular matter is described. The device includes a receiving container configured and adjusted for receiving the granular matter. The receiving container has an output for providing the granular matter to a further processing. The device has a measuring unit configured for measuring a density of the granular matter in the receiving container using terahertz spectroscopy.

### TECHNICAL FIELD

The invention relates to a device for providing a granular matter comprising a measuring unit for measuring a density of the granular matter using terahertz spectroscopy.

Moreover, embodiments of the invention relate to a method of providing granular matter and measuring a density of the granular matter by terahertz spectroscopy.

### Technological Background

Granular matters are used to produce products in many technological fields, e.g. in pharmaceuticals, food technology and/or cosmetic technology. For ensuring a constant and a reliably quality of the produced end product using granular matter, the granular matter has to be observed during the processing. In particular, the density during the processing of the granular matter and during a movement of the granular matter should to be observed. Changes in the density of the granular matter may have a direct impact to the end product in terms of weight variability, content uniformity and reproducibility. Depending on the material attributes, the setting of the processes and the devices conducting the processes and further environmental conditions the density of a granular matter may vary. Therefore, there may be a need for providing controlled processes for measuring and monitoring an actual state of the density of static and/or moving granular matter inside (and/or during) a process line.

### SUMMARY

There may be a need to improve the supply and/or dosage of granular matter for achieving product-specifications for final products.

In order to achieve the object defined above, a method and a device according to the independent claims are provided. Further exemplary embodiments are described in the dependent claims.

According to an exemplary embodiment a device for providing a granular matter is provided. The device comprises a receiving container configured and adjusted for receiving the granular matter, wherein the receiving container has an output for providing the granular matter to a further processing. The device further comprises a measuring unit which is configured for measuring a density of the granular matter in the receiving container using terahertz spectroscopy.

According to a further exemplary embodiment, a method of providing a granular matter is provided. The method comprises receiving the granular matter in a receiving container, wherein the receiving container has an output for providing the granular matter to a further processing. Further, the method comprises measuring a density of the granular matter in the receiving container by terahertz spectroscopy.

### Overview of Embodiments

In the context of the present application, the term “granular matter” may particularly denote a conglomeration of discrete solid, macroscopic particles of a material. Further, it may denote all kinds of powder, granules, pellets and the like. The granular matter may be an active pharmaceutical ingredient, a pharmaceutical powder, a pharmaceutical granule, a pharmaceutical pellet, a cosmetic granule, a cosmetic powder, a granule and/or powder used in food technology, but is not limited thereto. Also, excipients and/or other substances in the form of powders, granules or pellets may be measured, for example during the process of (micro-) dosing or (micro-) feeding using the inventive concept.

The term “terahertz spectroscopy” may particularly denote the measuring of properties of (granular) matter using electromagnetic fields in the range between a few hundred gigahertz and several terahertz (THz). For producing THz sources an antenna, a quantum-cascade laser, a free-electron laser, or optical rectification may be used. Using short THz pulses a variety of physical parameters may be measured with THz spectroscopy, e.g. complex permittivity or THz absorption coefficient and refractive index, respectively. According to the exemplary embodiment the THz measurements were acquired continuously during a processing process of the granular matter. A linear relationship may exist between the refractive index of the granular matter and the relative density of the granular matter. Hence, for measuring the density of a granular matter the refractive index of the respective granular matter may be measured by THz spectroscopy. A movement of the receiving container may have no effect on the measurement, which was analyzed during various experimental setups.

The term “receiving container” may particularly denote a reservoir applicable for receiving granular matter and further for feeding the granular matter to further devices, such as processing devices (for example dosator, compressors, granulators, tablet filling/forming devices). The density of granular matter may be observed during the movement of the granular matter through the receiving container, in particular the granular matter is in a moving state. On the other hand, the density of the granular matter may be observed, when the granular matter rests in the receiving container, in particular when the granular matter is in a static state.

The term “further processing” may particularly denote processing devices into which the granular matter is supplied for forming end products. For example, the further processing may be a pharmaceutical dosage formation process, such as capsule filling or tablet forming. Further, the further processing may be a formation of a cosmetic product, for example a powder compression process.

Measuring the density of granular matter may result in a measurement of a density variation of the granular matter over time during the static state or moving state of the granular matter. Due to different material characteristics the density of the granular matter may vary, e.g. due to segregation because of density differences of blend compounds, air entrapment in material layers of the granular matter, mechanical stresses occurring on the granular matter (for example after a dosing process of the granular matter the granular matter may be destructed in its mechanical structure), agglomeration, and densification. The device and the method may be used for controlling density variations inside a batch of granular matter and/or inside a continuous manufacturing process. The device and method may serve as a process analytical technology for a wide range of industrial applications, processes, and unit operations. Specially, the device and method may serve for a monitoring of density variations which may cause a deviation of the tolerance range (or so called out of specification), wherein a deviation in the end product made of the granular matter influences the quality and the quantity of the end product. For example, within a pharmaceutical process the density measurement may serve as a process control to control the critical quality attributes of the final product related to a specific process parameter (dosage of a pharmaceutical, the weight of the pharmaceutical), wherein a deviation of the standard density may result in a deviation of the properties of the pharmaceutical product.

According to an exemplary embodiment the measuring unit may be configured for measuring the density of the granular matter during providing the granular matter through the output. The receiving container receives the granular matter and provides the granular matter to further processing, during this providing through the output of the receiving container the density of the granular matter is measured. In particular the density is measured for a predetermined time period and/or for a plurality of times, such that density variations may be detected as a function of time, for controlling the processed granular matter and its material properties, i.e. the density. When measuring the density during the providing of the granular matter through the output, the measuring is performed as in-line measurement of the process. The granular matter is moving inside of the receiving container and in particular through the receiving container for being conveyed to the output. Further, it may be possible to measure the density of the granular matter, when the granular matter rests, e.g. is only filled into the receiving container without being further conveyed. Hence, the actual state of the density may be measured.

According to an exemplary embodiment the measuring unit may be configured for emitting primary electromagnetic radiation into the receiving container and for receiving secondary electromagnetic radiation, generated by an interaction between the primary electromagnetic radiation and the granular matter. In other words, the measuring unit is able to conduct the measurement of the density as reflection measurement (in particular the terahertz spectroscopy comprises reflective terahertz spectroscopy), wherein the secondary electromagnetic radiation is a backscattered electromagnetic radiation, which properties are changed by the granular matter. For instance, the emitted primary electromagnetic radiation beam may be directed from the measuring unit through the receiving container into the inside of the receiving container into the granular matter arranged inside the receiving container. A secondary electromagnetic radiation beam interacting with the granular matter may be able to propagate back through at least a part of the granular matter and the receiving container to the measuring unit for detection and data processing.

According to an exemplary embodiment the measuring unit may comprise a terahertz generating unit configured for generating the primary electromagnetic radiation. The measuring unit further comprises a radiating unit configured for radiating the terahertz electromagnetic radiation to the receiving container and for receiving the secondary electromagnetic radiation. The terahertz generating unit may be a portable unit arrangeable on varying positions at the device for providing granular matter and configured for performing both transmission and reflection measurement within a spectral range of for example 0.06 THz to 7 THz. The radiating unit may be a fiber-based flexible reflection probe used for process spectroscopy. The reflection probe comprises at least one emitter (light emitting fibers) for emitting electromagnetic radiation. Further, the reflection probe may comprise at least one detector (at least one light receiving fiber). The measuring unit may comprise more than one terahertz generating unit and more than one radiation unit for simultaneously generating and detecting more than one terahertz signal, such that a plurality of densities may be measured simultaneously. The radiation unit may also be a photoconductive antenna operable as transmitter or receiver. The radiation unit may be attachable to the device for providing granular matter by an attachment unit, wherein the attachment unit may be configured as a clamping unit and/or a screwing unit (wherein for example screws are used for attaching the radiation unit to the device for providing granular matter).

The measuring unit may further comprise a data processing unit configured for receiving data of the terahertz generating unit and/or data of the radiating unit. The received data may be analyzed and/or processed for obtaining density parameters which then may be compared with desired density parameters of the measured granular matter. In particular the data processing unit may be configured for receiving the measured refractive index of the measuring unit and may be configured for comparing the received refractive index with density parameters referring to the granular matter, which may be stored in the data processing unit.

According to an exemplary embodiment the measuring unit may be arrangeable on the outside of the receiving container for preventing interaction with the granular matter. For instance, the measuring of the density may be conducted in a contactless manner, wherein the measuring unit may only be coupled to the receiving container but not to the granular matter itself. In particular, the measuring unit may be arrangeable at different positions at the receiving container, such that the granular matter may be analyzed from different positions for obtaining information from different locations of the granular matter. For example, the measuring unit may be arrangeable at the output of the receiving container.

According to an exemplary embodiment the receiving container comprises an inlet coupled to the receiving container for receiving granular matter, wherein the granular matter is moving from the inlet to the output of the receiving container and wherein the measuring unit is configured for measuring the density if the granular matter is moving. In this embodiment the density (density variation) of the granular matter is analyzed during the moving state of the granular matter. Further, the measuring unit may be arrangeable at the inlet for measuring the density of the granular matter. It may also be possible that two radiation units (and two terahertz generating units) are used, wherein a first radiation unit (and a first terahertz generating unit) is arranged at the inlet and a second radiation unit (and a second terahertz generating unit) is arranged at the output for comparing the density variation at the inlet with the density variation at the output. Further, a third radiation unit (and a third terahertz generating unit) may be arranged for measuring the density variation at the inside of the receiving container. Hence, the density (and their variation over time) may be observed for a plurality of process steps.

According to an exemplary embodiment the receiving container further comprises a calibration unit configured for calibrate the measuring unit for the measurement of the respective granular matter density received inside the receiving container. The calibration unit may be configured for calibrating the measuring unit for the respective density, desired density, of the granular matter. In particular, the calibration unit is configured for determining the relative density of the granular matter to be measured and for providing the relative density to the measuring unit for the subsequent measurement of the density (variation) of the granular matter. The relative density may be dependent on the mass of the granular matter and on the filling volume of the receiving container. The refractive indexes of the respective granular matter are strongly correlated with the respective relative densities of the granular matter. Therefore, a linear model may be fitted to this calibration, wherein the relative density corresponds to the measured refractive index determined from the terahertz spectroscopy (including fitting parameters). For instance, the calibration unit may comprise a compression cell and/or a load cell configured for measuring a respective force applied to the granular matter. e.g. inside of the receiving container. The applied force may be applied by the force applying element as described below. In particular, the load cell may be a transducer configured for creating an electrical signal for data analyzing, wherein the electrical signal is proportional to the force being measured. Therefore, the load cell may be configured for measuring the force in dependence of the applied weight of the granular matter. The load cell may comprise at least one of the group of a hydraulic load cell, a pneumatic load cell, and a strain gauge load cell. By using a load cell, a precise control of the relative density may be possible, such that a broad range of relative densities may be measurable and the calibration is facilitated. For example, when the calibration is conducted with the granular matter arranged inside of the receiving container, the load cell may be arranged inside of the receiving container.

According to an exemplary embodiment the calibration unit further comprises a force applying element configured for applying a force to the granular matter for compressing the granular matter adjusting different density parameters of the granular matter. In particular, different density parameters may be obtained by applying different forces to the granular matter. The force applying element may be configured as a pressing plate which may arranged on top of the granular matter inside of the receiving container. The force applying element may also be a plunger pushing on top of the granular matter inside of the receiving container. The force applying element may be used for applying different forces on the granular matter for receiving different compression states of the granular matter. Each compression state may comprise a different density, such that the calibration unit may be able to determine different densities of one granular matter under different compression states.

According to a further exemplary embodiment, the receiving container may comprise a motor configured for moving the receiving container in such a manner that the granular matter may move from the inlet to the output.

According to an exemplary embodiment the receiving container is configured as at least one of the group consisting of a feeder, a blender, a rotary container of a capsule filling machine, a storage device, a granulator, roller compactor, twin-screw granulator, a tamping pin device, and tableting machine. The receiving container may be any container able to receive granular matter. In particular, the receiving container may be a feeder, e.g. a continuous feeder feeding and/or dosing granular matter, which may be able to dose flowing granular matter in respective dosing portions. In particular, the receiving container may be a blender, configured for mixing different granular matter. In particular, the receiving container may be a storage device for storing the granular matter over a certain period of time, wherein the density of the granular matter may be measured in a static state. In particular, the receiving container may be a rotary container of a capsule filling machine, for example for a pharmaceutical product. The rotary container may be rotatable by the motor such that the density may be measured in a moving state. In particular, the receiving container may be a compactor, e.g. roller compactor, which compacts the received granular matter by compression. Hence, the density may be measured before and after compacting of the granular matter. In particular, the receiving container may be a granulator, which may break or mill the granular matter from a bigger size to a smaller size, wherein the density may be measured before and after the milling of the granular matter. In particular, the receiving container may be a tableting machine, wherein the density of the granular matter may be measured before the granular matter is inserted into a tablet and after insertion into the tablet.

According to an exemplary embodiment the receiving container is rotatable around a rotation axis of the receiving container, for rotating the granular matter. For instance, the receiving container may be the rotatable cylinder which may be rotated along its rotation axis for providing a movement of the granular matter. The receiving container may perform a plurality of rotating cycles. For example, the speed of the rotation may be adjustable, such that the receiving container may be able to rotate at different velocities.

According to an exemplary embodiment the receiving container is movable along a direction perpendicular to a rotational axis of the receiving container and/or along a direction parallel to the rotational axis, for moving the granular matter. For instance, the receiving container is movable along at least two directions of a horizontal axis and/or a vertically axis. Descriptive speaking the receiving container may be movable from the left to the right and from up to down, and vice versa. The movement of the receiving container may be able to change the density properties of the granular matter and/or for moving the granular matter out of the container. For instance, the density of the granular matter may be changed, such that it is compacted and/or loosened up.

According to an exemplary embodiment the receiving container further comprises a vibration unit configured for vibrating the receiving container and the granular matter. The vibration unit may be directly coupled to the receiving container for transferring the vibrations to the receiving container. The granular matter may be moved by the vibrations from the inlet to the output of the receiving container, such that a density of the granular matter may be measured in a moving state of the granular matter.

According to an exemplary embodiment, wherein the receiving container comprises a material permeable for terahertz radiation. For example, the receiving container may be made of a dielectric material, e.g. plastic, ceramic. The use of terahertz permeable material for the receiving container may guarantee that the measurement of the density may not be influenced by the material of the receiving container, which the primary electromagnetic radiation has to pass and through which the secondary electromagnetic radiation is backscattered.

In the following exemplary embodiments of the method will be described.

According to a further exemplary embodiment of the method, the density may be measured during providing the granular matter through the output. The measurement may be conducted during the process of feeding, or storing, or dosing of the granular matter from the receiving container to the further processing. Therefore, the measuring of the density may be performed as in-line process measurement.

According to a further exemplary embodiment of the method, information indicative of the density is detected in a plurality of consecutive time intervals or continuously in time. The time evolution of the reflected electromagnetic radiation may be measured as a function of time. Therefore, one may collect information indicative of the density completely in time domain. The measured density may be associated to a specific time, such that for example to a specific time environmental influences or device parameters may be associates and their influence on the density variation of the granular matter.

In particular, the measuring is conducted in the framework of a granular matter processing process for monitoring the processing quality.

According to a further exemplary embodiment of the method, the measuring is conducted while the granular matter is moving. Hence, the density may be measured during a movement of the granular matter, such that processing steps of the granular matter have not to be stop. This may provide the advantage that a movement of the granular matter, in particular also a movement of the receiving container may have no influence on the measured density, such that the measurement may be conducted as in-line process.

According to a further exemplary embodiment of the method, may further comprise comparing of the measured density of the granular matter with a desired density of the granular matter. The comparison of the measured density with a desired density may provide information about a derivation of the density of the processed granular matter to the desired granular matter for the end product. For instance, if a deviation may be detected the density may be adapted, e.g. the density may be changed by the device or by a user, to the desired density for ensuring a constant and reliably end product quality.

According to a further exemplary embodiment of the method, may further comprise averaging measured density by an average filter for reducing noise. By using an average filter occurred noise influencing the measured signal may be reduced. For example, an average filter with a size of 10 may be used for reducing the noise.

The measurement of the density may be conducted at different position of the receiving container for serval times, such that for different positions a plurality of measurements may exist. This may provide the opportunity for determining density variations over time at a plurality of positions. Further, the averaging of the measured signal may not only decrease the noise but also increase the accuracy of the relative density values per measurement position.

It has to be noted that embodiments have been described with reference to different subject matters. In particular, some embodiments have been described with reference to apparatus type claims whereas other embodiments have been described with reference to method type claims. However, a person skilled in the art will gather from the above and the following description that, unless other notified, in addition to any combination of features belonging to one type of subject matter also any combination between features relating to different subject matters, in particular between features of the apparatus type claims and features of the method type claims is considered as to be disclosed with this application.

The aspects defined above and further aspects are apparent from the examples of embodiment to be described hereinafter and are explained with reference to these examples of embodiment.

Embodiments of the invention will be described in more detail hereinafter with reference to examples of embodiment but to which the invention is not limited.

### BRIEF DESCRIPTION OF THE DRAWINGS

FIG. 1 illustrates a device for providing granular matter comprising a measuring unit according to an exemplary embodiment.

FIG. 2 illustrates a device for providing granular matter equipped with a calibration unit according to an exemplary embodiment.

FIG. 3 illustrates a device for providing granular matter according to an exemplary embodiment, configured as a dosator system.

FIG. 4 illustrates a device for providing granular matter according to an exemplary embodiment, configured as a tamping pin system.

FIG. 5 illustrates a density variation measured by the measuring unit according to an exemplary embodiment.

FIG. 6 illustrates a device for providing granular matter according to an exemplary embodiment, configured as a compacting roller system.

### DETAILED DESCRIPTION OF ILLUSTRATED EMBODIMENTS

The illustrations in the drawings are schematically presented. In different drawings, similar or identical elements are provided with the same reference signs.

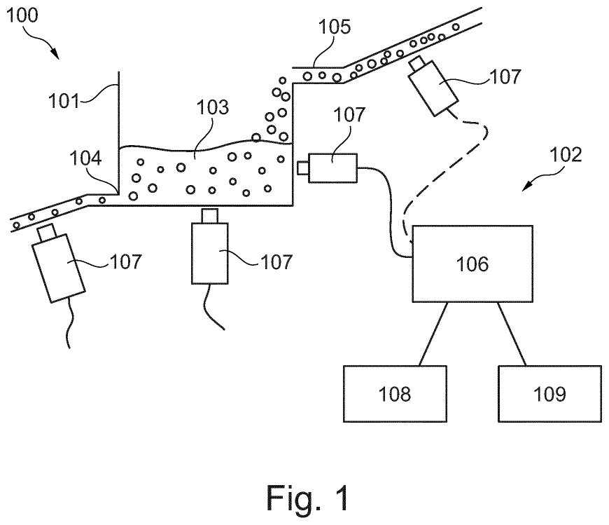

In the following, referring to FIG. 1 a device 100 for providing granular matter 103 is illustrated. The device 100 comprises a receiving container 101 which may receive the granular matter 103 inside. The receiving container has an output 104 and an inlet 105 through which the granular matter 103 may flow. Through the output 104 the granular matter 103 is provided to further processing. Further, the device 100 comprises a measuring unit 102 which is configured for measuring a density of the granular matter 103 inside of the receiving container 101 using terahertz spectroscopy. The inlet 105 is coupled to the receiving container 101 for receiving the granular matter 103, wherein the granular matter 103 is moving from the inlet 105 to the output 104 of the receiving container 101. The measuring unit 102 may measure the density of the granular matter 103, when the granular matter 103 is moving from the inlet 105 to the output 104. In particular, the measuring unit may be configured for measuring the density of the granular matter 103 during providing the granular matter 103 through the output 104. The measuring unit 102 is configured for emitting primary electromagnetic radiation into the receiving container 101 and for receiving secondary electromagnetic radiation, generated by an interaction between the primary electromagnetic radiation and the granular matter 103. The measuring unit 102 comprises a terahertz generating unit 106 configured for generating the primary electromagnetic radiation and a radiating unit 107 configured for radiating the terahertz electromagnetic radiation to the receiving container 101 and for receiving the secondary electromagnetic radiation. The measuring unit 102 is arrangeable on the outside of the receiving container 101 for preventing interaction with the granular matter 103. In particular both the terahertz generating unit 106 and the radiation unit 107 are arranged outside of the receiving container 101. The radiation unit 107 may be arranged adjacent to the receiving container 101, or in particular adjacent with a low distance to the position at the device 100 where the measurement should be conducted. It may also be possible that the radiation unit 107 is in contact with an outer surface of the receiving container 101 such that the primary electromagnetic radiation may have a small distance to pass into the receiving container 101. The material of the receiving container 101 may be made of material permeable for terahertz radiation. The radiation unit 107 is positionable at a plurality of positions at the device 100. In FIG. 1 at least four possible positions are illustrated. For instance, the radiation unit 107 may be positionable at the inlet 105, at the output 104 at the side of the receiving container and/or at the bottom of the receiving container 107. It is also possible that all positions are used, such that for instance four radiation units 107 are used for the measuring of the density at the different positions. Each of the respective radiation units 107 may be coupled to the terahertz generating unit 106. On the other hand, it may also be possible that each of the respective radiation units 107 is coupled to a respective terahertz generating unit 106, such that according to FIG. 1 four terahertz generating units 106 and four radiation units 107 are used for the four positions. Further, the device 100 comprises a data processing unit 109 for processing the received information relating to the measured density of the granular matter 103. The data processing unit 109 may be coupled to the measuring unit 102, in particular the data processing unit 109 may be coupled to the terahertz generating unit 106. Further, the device 100 comprises a calibration unit 108 configured for calibrate the measuring unit 102 for the measurement of the respective granular matter 103 density received inside the receiving container 101. The calibration unit 108 may be coupled to the measuring unit 102, in particular the calibration unit 108 may be coupled to the terahertz generating unit 106.

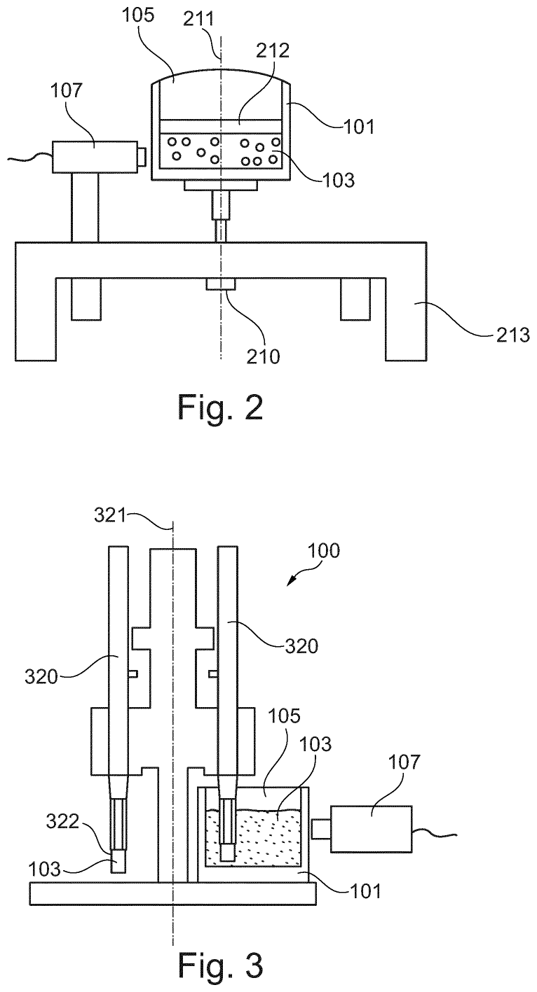

In the following, referring to FIG. 2 a device 100 for providing granular matter 103 according to a further exemplary embodiment is illustrated. In particular, in FIG. 2 the calibration unit 109 is illustrated in detail. The calibration unit 109 comprises a force applying element 212 configured for applying a force to the granular matter 103 for compressing the granular matter. In this exemplary embodiment the receiving container 101 is configured as a rotary container in which the granular matter 103 is arranged. The inlet 105 of the receiving container 101 may be the top opening of the receiving container 101. On top of the granular matter 103 the force applying element 212 is arranged. The force applying element 212 is configured as a metal plate, in particular as a metal ring. The force applying element 212 may be attached to the inside of the receiving container 101. The receiving container 101 is rotatable along a rotation axis 211 of the receiving container 101. The rotation of the receiving container 101 may be performed by a motor 210. Further, the receiving container 101 is movable, along a direction perpendicular to the rotational axis 211 of the receiving container 101, for moving the granular matter. For example, the receiving container is movable from the left to the right side illustrated in FIG. 2. A radiation unit 107 is arranged at the receiving container 101 for measuring the density of the granular matter 103. Different densities may be applied to the granular matter 103 using the force applying element 212, wherein the force applying element is attached inside of the receiving container 101 at different heights. The adjustment of the height of the force applying element 212 may be performed by screws attaching the force applying element 212 to the receiving container 101. For each height a different density exists due to the differentiating forces applied to the granular matter 103. The calibration unit may store the measured densities for providing the measured densities as reference parameters to the measuring unit 102 of the device 100 for providing granular matter. The calibration unit 109 may be attached to a bench or a frame 213.

In the following, referring to FIG. 3 an exemplary embodiment of the device 100 is illustrated, wherein the device is configured as a dosator system 320. The dosator system comprises the receiving container 101, wherein the inlet 105 pf the receiving container 101 may be the top opening into which the granular matter is introduced. Further, the dosator system 320 may comprise at least one dosator 320, in FIG. 3 two dosators are illustrated. The dosator 320 is able to remove granular matter 103 out of the receiving container 101, such that the dosator 320 may function as the output of the receiving container 101. The dosators 320 are arranged at a support holding the dosators, wherein the dosators 320 are able to perform a movement along a dosator system axis 321 for removing granular matter out of the receiving container 101. In FIG. 3 one dosator is arranged inside the receiving container 101 and another dosator 320 is arranged outside of the receiving container 101. The dosator 320 comprises a dosator tip configured for receiving and/or for holding the granular matter for providing the granular matter to further processing. The dosator 320 arranged at the outside of the receiving container may hold granular matter in the dosator tip 322 such that the granular matter may be released from the dosator tip 322 to the further processing. The radiation unit 107 of the measurement system 102 is arranged for having an insight into the receiving container 101. Hence the radiation system 107 may be able to measure the density before inserting the dosator and after the insertion of the dosator. For instance, the radiation unit 107 may be able to measure the granular matter inside of the dosator tip 322.

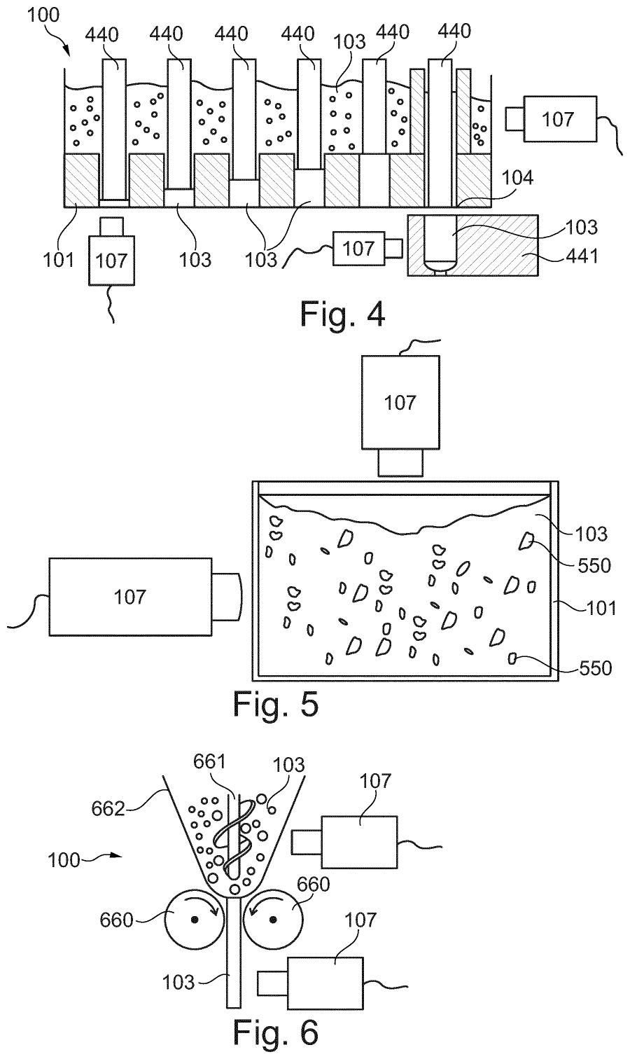

In the following, referring to FIG. 4 a device 100 according to a further exemplary embodiment is illustrated, wherein the device 100 is configured as a tamping pin device. The device 100 comprises at least one tamping pin 440 configured for compressing a part of the granular matter 103 in the receiving container 101. As can be seen in FIG. 4 different states of the tamping pin 440 are shown, which illustrate the different compression states of the granular matter 103. On the other side, it may also be possible that the device 100 comprises a plurality of tamping pins 440. The receiving container 101 may comprise an output 104 through which the granular matter 103 is releasable by the tamping pin 440, wherein the tamping pin is configured in such a manner that the tamping pin 440 is movable through the inner volume of the receiving container 101 and through the output 104 of the receiving container. In the last state, shown in the right side of FIG. 4, the compressed granular matter 103 is ejected out of the receiving container 101 and provided to further processing. The receiving container may have a plurality of outputs 104, such that for each tamping pin 440 an output 104 is provided. The granular matter is released by the tamping pin 440 into a receiving element configured for providing the (compressed) granular matter 103 to further processing. The receiving element 441 may be a tablet or a compact/plug which is filled into a capsule. The radiation unit 107 may be arranged on the device 100 in such a manner that it is able to measure the density of the granular matter 103 before the compressed state (wherein the radiation unit 107 is arranged adjacent to the receiving container 101) and/or in the compressed state, i.e. after compression (wherein the radiation unit 107 is not arranged at the receiving container 101, instead the radiation unit 107 is arranged at the further processing).

In the following, referring to FIG. 5 a measurement of the density of granular matter 103 is illustrated. The granular matter 103 is located inside of the receiving container 101. The granular matter 103 comprises a plurality of inclusions which influence the density of the granular matter 103. The radiation unit 107 is arranged at the receiving container 101 for measuring the density. Depending on the inclusions 550 the density measured by the radiation unit 107 may vary. For examples the density measured from the left side of FIG. 5 differs from the density measured from the top of the receiving container 101.

In the following, referring to FIG. 6 a device 100 according to a further exemplary embodiment is illustrated, wherein the device 100 is configured as a roller compactor. The roller compactor device 100 comprises a receiving container 101 formed as a funnel 662, such that the granular matter 103 may flow from the top of the funnel 662 to the bottom of the funnel 662. The top of the funnel 662 may be the inlet of the receiving container 101 and the bottom may be the output of the receiving container 101. The radiation unit 107 measures the density of the granular matter 103 inside of the funnel 662. The device in FIG. 6 further comprises compacting roller 660, which are configured for compacting the granular matter 103 leaving the funnel 662. A further (or also the same) radiation unit 107 measures the density of the compacted granular matter 103 leaving the funnel 662. Inside of the funnel 662 a spinner 661 may be arranged, which may be configured for stirring the granular matter 103 and therefore for being arranged for changing the density of the granular matter 103 inside of the funnel 662.

It should be noted that the term “comprising” does not exclude other elements or steps and the article “a” or “an” does not exclude a plurality. Also, elements described in association with different embodiments may be combined.

Implementation of the invention is not limited to the preferred embodiments shown in the figures and described above. Instead, variations are possible which use the solutions shown and the principle according to the invention even in the case of fundamentally different embodiments.

### LIST OF REFERENCE SIGNS

100 device for providing a granular matter
101 receiving container
102 measuring unit
103 granular matter
104 output
105 inlet
106 terahertz generating unit
107 radiation unit
108 calibration unit
109 data processing unit
210 motor
211 rotation axis
212 force applying element
213 bench
320 dosator system
321 dosator system axis
322 dosator tip
440 tamping pin
441 receiving element
550 inclusion
660 compacting roller
661 spinner
662 funnel

1. A device for providing a granular matter, the device comprising:
a receiving container configured and adjusted for receiving the granular matter, wherein the receiving container has an output for providing the granular matter to a further processing, and
a measuring unit configured for measuring a density of the granular matter in the receiving container using terahertz spectroscopy.

2. The device according to claim 1, wherein the measuring unit is configured for measuring the density of the granular matter during providing the granular matter through the output.

3. The device according to claim 1, wherein the measuring unit is configured for emitting primary electromagnetic radiation into the receiving container and for receiving secondary electromagnetic radiation, generated by an interaction between the primary electromagnetic radiation and the granular matter.

4. The device according to claim 1, wherein the measuring unit comprises
a terahertz generating unit configured for generating the primary electromagnetic radiation,
a radiating unit configured for radiating the terahertz electromagnetic radiation to the receiving container and for receiving the secondary electromagnetic radiation.

5. The device according to claim 1, wherein the measuring unit is arrangeable on the outside of the receiving container for preventing interaction with the granular matter.

6. The device according to claim 1, wherein the receiving container comprises
an inlet coupled to the receiving container for receiving granular matter, wherein the granular matter is moving from the inlet to the output of the receiving container,
wherein the measuring unit is configured for measuring the density if the granular matter is moving.

7. The device according to claim 1, wherein the receiving container further comprises
a calibration unit configured to calibrate the measuring unit for the measurement of the respective granular matter density received inside the receiving container.

8. The device according to claim 7, wherein the calibration unit comprises a force applying element configured for applying a force to the granular matter for compressing the granular matter adjusting density parameters of the granular matter.

9. The device according to claim 1, wherein the receiving container is configured as at least one of the group consisting of a feeder, a blender, a rotary container of a capsule filling machine, a storage device, a granulator, roller compactor, twin-screw granulator, a tamping pin device, and tableting machine.

10. The device according to claim 1, wherein the receiving container is rotatable, around a rotation axis of the receiving container for rotating the granular matter.

11. The device according to claim 1, wherein the receiving container is movable along a direction perpendicular to a rotational axis of the receiving container and/or along a direction parallel to the rotational axis.

12. The device according to claim 1, wherein the receiving container further comprises a vibration unit configured for vibrating the receiving container and the granular matter.

13. The device according to claim 1, wherein the receiving container comprises a material permeable for terahertz radiation.

14. A method of providing a granular matter, the method comprising:
receiving the granular matter in a receiving container, wherein the receiving container has an output for providing the granular matter to a further processing, and
measuring a density of the granular matter in the receiving container by terahertz spectroscopy.

15. The method according to claim 14, wherein the density is measured during providing the granular matter through the output.

16. The method according to the claim 14, wherein information indicative of the density is detected in a plurality of consecutive time intervals or continuously over time.

17. The method according to claim 14, wherein the measuring is conducted while the granular matter is moving.

18. The method according to claim 14, further comprising:
comparing of the measured density of the granular matter with a desired density of the granular matter.

19. The method according to claim 14, further comprising:
averaging measured density by an average filter for reducing noise.
